(19) United States
(12) Patent Application Publication
(10) Pub. No.: US 2006/0170731 A1
(43) Pub. Date: Aug. 3, 2006

(54) Fluid injection device and method of fabricating the same

(75) Inventors: Kuo-Tong Ma, Taipei (TW); In-Yao Lee, Taipei (TW); Hung-Sheng Hu, Kaohsiung (TW)

Correspondence Address: BIRCH STEWART KOLASCH & BIRCH, PO BOX 747, FALLS CHURCH, VA, 22040-0747, US

(73) Assignee: BENQ CORPORATION, Taoyuan (TW)

(21) Appl. No.: 11/297,432

(22) Filed: Dec. 9, 2005

(30) Foreign Application Priority Data
Dec. 13, 2004 (TW) 93138576

(51) Int. Cl. B41J 2/135

(52) U.S. Cl. 347/44

(57) ABSTRACT

A fluid injection device. The fluid injection device comprises a substrate, a chamber formed in the substrate, a structural layer covering the substrate and the chamber, at least one nozzle through the structural layer and connecting the chamber, an opening through the structural layer and connecting the terminal of the chamber, wherein an outlet is formed at the connecting region therebetween. A method of fabricating the fluid injection device is also disclosed.

### BACKGROUND

The present invention relates to a fluid injection device, and more specifically to a fluid injection device which can remove residual bubbles from a chamber and a method of fabricating the same.

In various inkjet printing applications, excellent printing quality is a goal for users and fabricators. Inkjet stability, however, is a significant factor affecting quality of printing.

For a heating-type inkjet printer, ink is compressed to inject from nozzles to form a droplet by bubbles formed by heating. Thus, sizes of bubbles or residual bubbles inside a chamber may significantly affect stability of the inkjet.

A related heating fluid injection device and its inkjet process are disclosed in U.S. Pat. No. 6,102,530. Referring to FIG. 1, the fluid injection device 10 comprises a substrate 12, a manifold 14 formed in the substrate 12 by etching, to supply ink, a chamber 16 formed in the substrate 12 by anisotropic etching after removing sacrificial layer, to contain ink, a structural layer 18 covering the chamber 16 and the substrate 12, a heater 20 installed on the structural layer 18 to drive ink, a passivation layer 22 covering the heater 20 and the structural layer 18, and a nozzle 24 through the passivation layer 22 and the structural layer 18 to inject ink, wherein the chamber 16 connects the manifold 14 and the nozzle 24.

The inkjet process of the above device is illustrated in FIG. 2. First, ink is heated to vapor by the heater 20 on the chamber 16, rapidly producing two bubbles 26 and 28. The progressively growing bubbles 26 and 28 then compress ink out of the nozzle 24, forming a droplet 30. In an ideal state, the production rates and volumes of the two bubbles 26 and 28 are identical so that their compression forces on ink are also identical. Thus, the droplet 30 can be vertically injected without declination.

A real state, however, is distinct from the ideal state. Referring to FIG. 3A, due to the specific conformation of the terminal region 34 of the chamber 32, ink cannot fill the terminal of the chamber 32, thus producing residual bubbles 36. If the residual bubbles 36 cannot be removed, two non-uniform bubbles 38 and 40 may then be created to generate different compression forces on ink, thus declining the trace of the injected droplet 42, as shown in FIG. 3B.

Quality of printing is controlled by accuracy of placement of a droplet on media. Referring to FIG. 4, if speed and direction of an injected droplet cannot be fixed, such as having various initial speeds or injection angles αzz, each droplet may thus have different trajectory (such as 1 or 1′), resulting in producing a distance deviation d, deteriorating print quality. The injection deviation is caused by accumulated residual bubbles inside a chamber.

Therefore, it is necessary to develop a method which can remove residual bubbles to stabilize injection quality.

### SUMMARY

The invention provides a fluid injection device having an outlet and fluid channel to remove residual bubbles from a chamber, stabilizing injection quality.

The invention provides a fluid injection device comprising a substrate, a chamber formed in the substrate, a structural layer covering the substrate and the chamber, at least one nozzle through the structural layer and connecting the chamber, an opening through the structural layer and connecting the terminal of the chamber, wherein an outlet is formed at the connection region therebetween.

If residual bubbles are produced during ink filling, the residual bubbles can be rapidly removed from the outlet situated at the terminal of the chamber, protecting two subsequently formed bubbles from compression forces of the residual bubbles. Additionally, the outlet is smaller than the nozzle so that flow resistance around the outlet exceeds that of the nozzle. Thus, during injection, droplets are ejected from the nozzle exactly, not the outlet, thereby avoiding undesired spots on media.

The invention provides another fluid injection device comprising a substrate, a chamber comprising a fluid channel formed in one side thereof in the substrate, and a structural layer covering the substrate and the chamber, wherein a protrusion of the structural layer embedded in the chamber isolates the fluid channel and the chamber.

The described fluid channel formed in the chamber speeds ink flow toward the terminal of the chamber to reduce production of residual bubbles, improving print quality.

The invention further provides a method of fabricating the fluid injection device, comprising the following steps. First, a substrate is provided. Next, a patterned sacrificial layer is formed on the substrate, wherein the patterned sacrificial layer is a predetermined region of a chamber. Next, a patterned structural layer is formed on the substrate to cover the patterned sacrificial layer. Next, a manifold is formed through the substrate to expose the patterned sacrificial layer. Next, the sacrificial layer is removed to form the chamber. Finally, the structural layer is etched to form at least one nozzle connecting the chamber and an opening, wherein the opening passes through the structural layer and connects the terminal of the chamber, and an outlet at the connection region there between is formed.

The invention provides another method of fabricating the fluid injection device, comprising the following steps. First, a substrate is provided. Next, a patterned sacrificial layer is formed on the substrate, wherein the patterned sacrificial layer is a predetermined region of a chamber, and at least one side thereof comprises a cavity. Next, a patterned structural layer is formed on the patterned sacrificial layer and filled into the cavity to form a protrusion. Next, a manifold through the substrate is formed to expose the patterned sacrificial layer. Next, the sacrificial layer is removed to form a chamber with the protrusion, wherein a fluid channel is formed between the protrusion and the wall of the chamber. Finally, the structural layer is etched to form at least one nozzle connecting the chamber.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a cross section of a related fluid injection device.

FIG. 2 shows ideal injection behavior of a fluid injection device.

FIG. 3A shows ink filling of a fluid injection device.

FIG. 3B shows injection behavior of a fluid injection device when residual bubbles are formed.

FIG. 4 shows a comparison of various points of impact.

FIG. 5A is a top view of a fluid injection device of the invention.

FIGS. 5B-5D are cross sections of the method of fabricating a fluid injection device of the invention.

FIG. 6 is a top view of another fluid injection device of the invention.

FIG. 7A is a top view of another fluid injection device of the invention.

FIGS. 7B-7D are cross sections of the method of fabricating another fluid injection device of the invention.

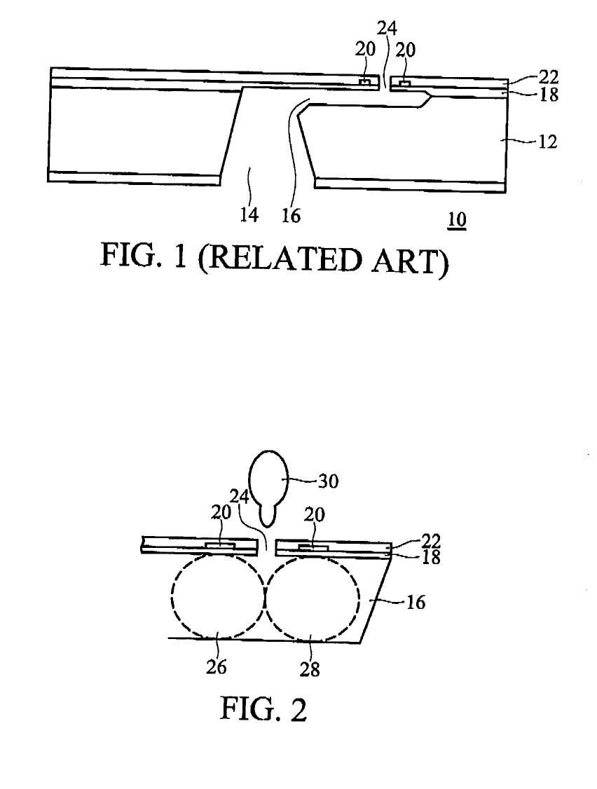

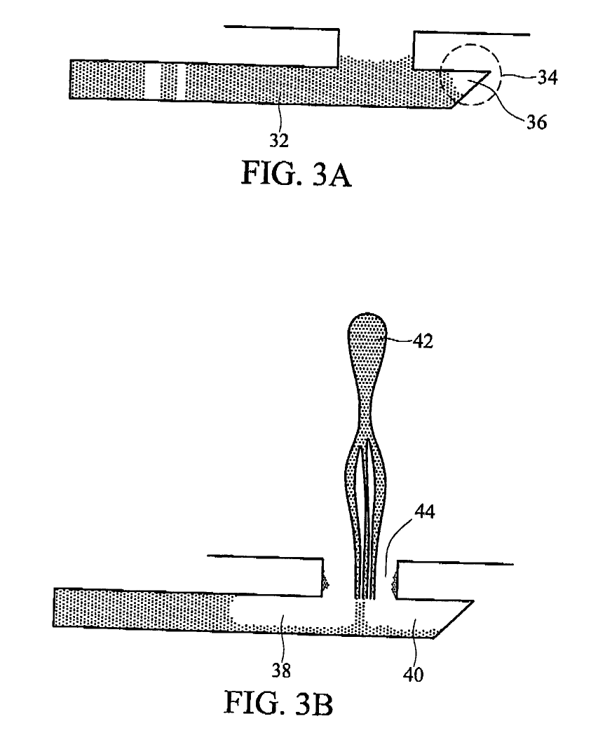

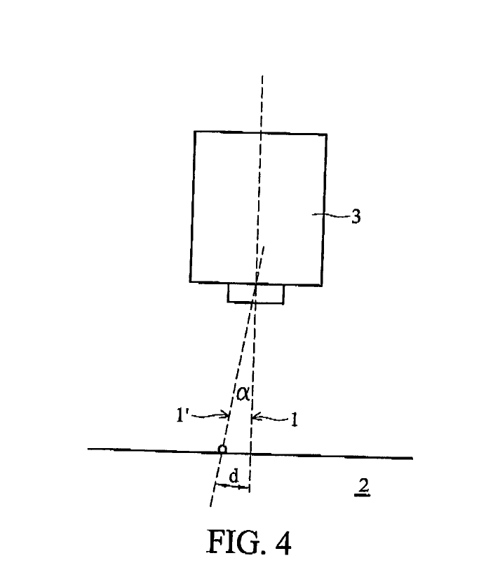

### DETAILED DESCRIPTION

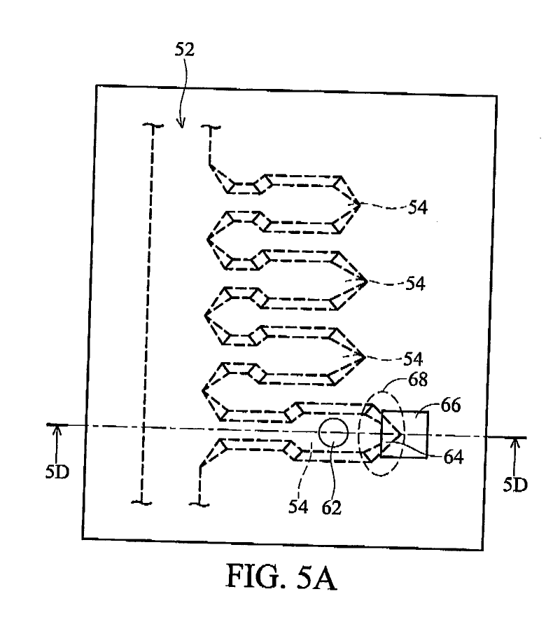

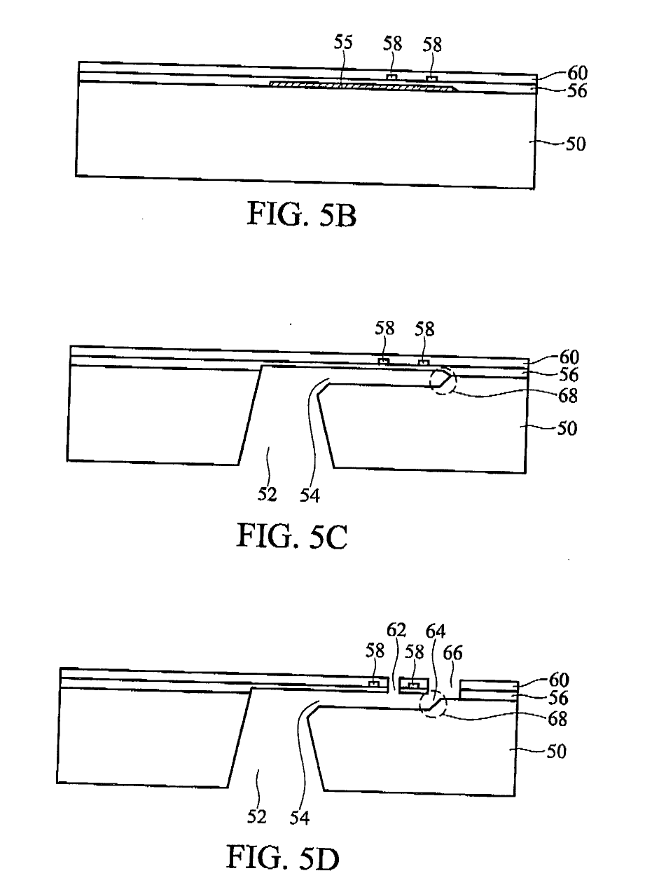

The structural features of the first fluid injection device are illustrated in FIGS. 5A and 5D, wherein FIG. 5D is a cross section along the tangent line 5D-5D of FIG. 5A. Referring to FIG. 5D, the terminal region 68 of the chamber 54 connects the opening 66 through the outlet 64, wherein the outlet 64 has a smaller equivalent radius than the nozzle 62. Referring to FIG. 5A, the terminal region 68 of the chamber 54 is tapered 70 because the substrate 50 is silicon having a crystal orientation

Additionally, the opening 66 is rectangular, and the outlet 64 is triangular.

Referring to FIG. 5D, the device structure comprises a substrate 50, a manifold 52, a chamber 54, a structural layer 56, a heater 58, a passivation layer 60, a nozzle 62, an outlet 64, and an opening 66.

The structural layer 56 covers the substrate 50 and the chamber 54. The heater 58 is installed on the structural layer 56, and on both sides of the nozzle 62. The passivation layer 60 covers the structural layer 56. A nozzle 62 passes through the passivation layer 60 and the structural layer 56 to connect the chamber 54. The opening 66 connects the terminal region 68 of the chamber 54. The outlet 64 is formed at the connection region between the opening 66 and the terminal region 68 of the chamber 54.

The invention provides an air exhaust route, such as an outlet 64 formed at the terminal region 68 of the chamber 54, to remove residual bubbles therefrom. The outlet 64 has a smaller equivalent radius than the nozzle 62, causing increased flow resistance around the outlet 64. Thus, droplets are ejected from the nozzle 62 exactly, not the outlet 64, avoiding undesired spots.

The relationship between flow resistance and outlet is illustrated by equation (1), wherein Δ p represents pressure drop of ink, μ represents viscosity of ink, r represents radius of outlet, L represents length of outlet, Q represents volumetric flow rate of ink, and R_{flow} represents flow resistance.
Δp=(8 μL/πr⁴) Q=R_{flow}Q (1)

According to the above equation, when the volumetric flow rate (Q) is fixed, if the radius (r) of the outlet decreases, the flow resistance (R_{flow}) may increase. Thus, the invention provides the outlet 64 having a smaller radius than the nozzle 62 to limit ink flow toward the outlet 64.

Referring to FIG. 5B-5D, a method of fabricating the fluid injection device is provided. First, referring to FIG. 5B, a substrate 50 is provided, such as a silicon substrate having a crystal orientation [110]. The thickness of the substrate 50 is about 625-675 μm. Subsequently, a patterned sacrificial layer 55 is formed on the substrate 50 as a predetermined region of a chamber. The sacrificial layer comprises BPSG, PSG, or silicon oxide, preferably PSG. The thickness of the sacrificial layer is about 1-2 μm.

Next, a patterned structural layer 56 is formed on the substrate 50 to cover the patterned sacrificial layer 55. The structural layer 56 may be silicon oxide nitride formed by CVD. The thickness of the structural layer 56 is about 1.5-2 μm. Subsequently, a heater 58 is formed on the structural layer 56 and on both sides of the subsequently formed nozzle to impel fluid. The heater 58 comprises HfB₂, TaAl, TaN, or TiN, preferably TaAl. Finally, a passivation layer 60 is formed on the structural layer 56.

Subsequently, referring to FIG. 5C, a series of etching steps is performed. First, the back of the substrate 50 is etched by anisotropic etching using KOH as an etching solution to form a manifold 52, exposing the sacrificial layer. The width of the narrow opening of the manifold 52 is about 160-200 μm, with the width of wider opening thereof about 100-1200 μm. The included angle between the side walls of the manifold 52 and the horizontal factor is about 54.74°. Thus, after etching, a manifold 52 with a back opening larger than a front opening is formed. Additionally, the manifold 52 connects to a fluid storage tank.

Next, the sacrificial layer is removed by HF, and the substrate 50 is subsequently etched by a basic etching solution, such as KOH, to enlarge the vacant volume thereof, forming the chamber 54. The terminal region 68 of the chamber 54 is tapered due to the crystal orientation [110] of the substrate 50. Finally, referring to FIG. 5D, the passivation layer 60 and the structural layer 56 are etched in order by plasma etching, chemical vapor etching, laser etching, or reactive ion etching (RIE) to form at least one nozzle 62 connecting the chamber 54.

When the nozzle 62 is etched, the structural layer 56 above the terminal region 68 of the chamber 54 is etched simultaneously to form an outlet 64 at the terminal region 68 of the chamber 54 and an opening 66 through the structural layer 56, creating an air exhaust route, as shown in FIG. 5D. Referring to FIG. 5A, the outlet 64 is triangular. The outlet 64 has a smaller equivalent radius than the nozzle 62, width radius is about 2-30 μm, preferably 4-15 μm.

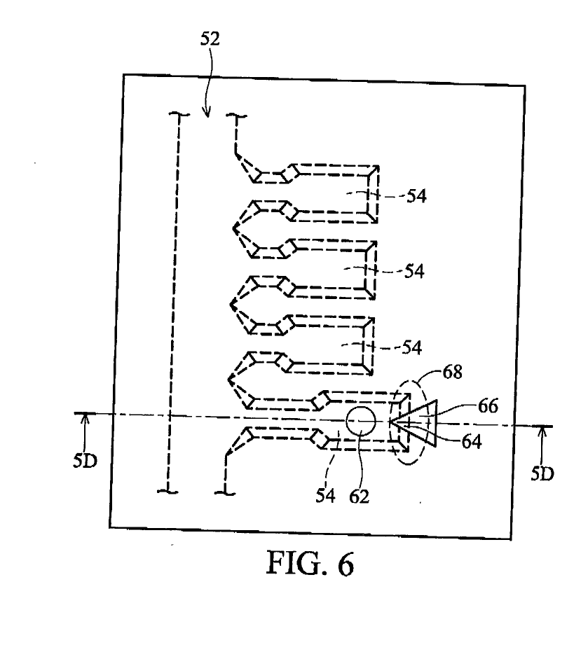

The structural features of the second fluid injection device are illustrated in FIGS. 6 and 5D, wherein FIG. 5D is a cross section along the tangent line 5D-5D of FIG. 6. Referring to FIG. 5D, the terminal region 68 of the chamber 54 connects the opening 66 through the outlet 64, wherein the outlet 64 has a smaller equivalent radius than the nozzle 62. Referring to FIG. 6, the terminal region 68 of the chamber 54 is rectangular due to the substrate 50 comprising silicon having crystal orientation [100]. Additionally, the opening 66 is tapered, and the outlet 64 is triangular. The distinction between the first and second fluid injection device is that the former selects [110] silicon substrate, but the latter selects [100] silicon substrate.

The fabrication methods of the first and second injection devices are similar. The distinction between the two methods is merely use of different silicon substrates (such as [110] or [100]), thus forming varied chamber shapes.

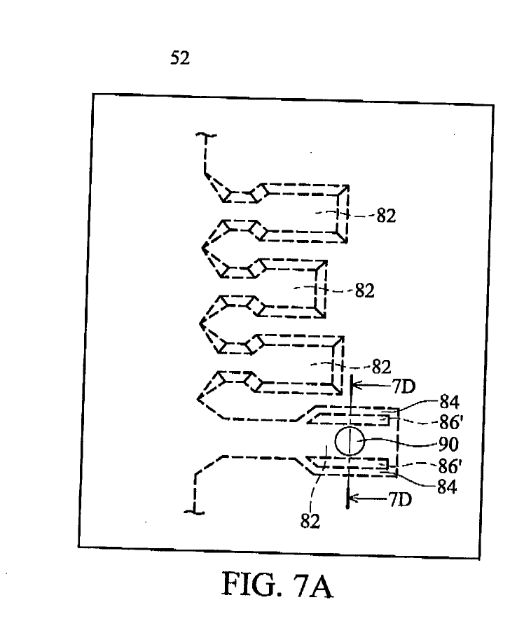

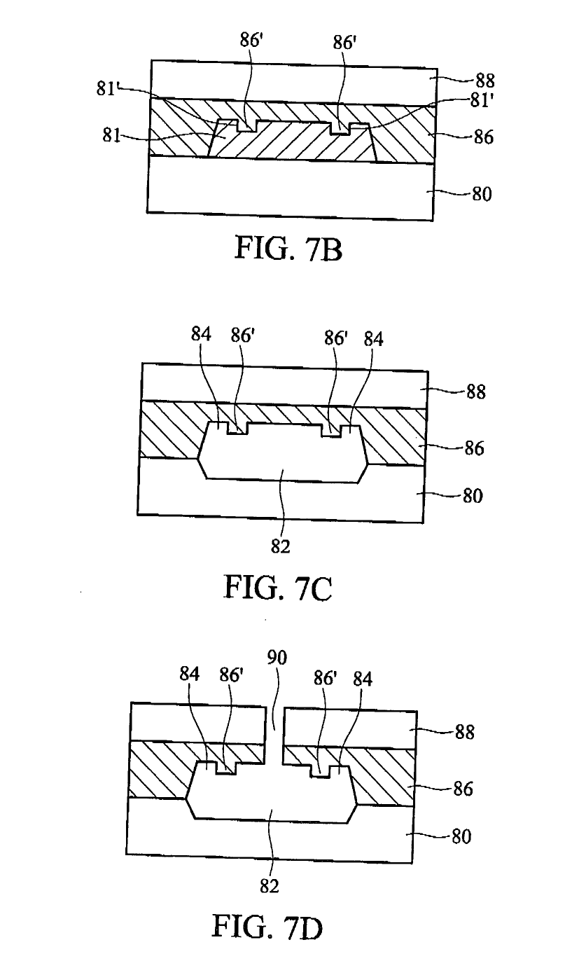

The structural features of the third fluid injection device are illustrated in FIGS. 7A and 7D, wherein FIG. 7D is a cross section along the tangent line 7D-7D of FIG. 7A. Referring to FIG. 7D, the fluid channel 84 is formed in at least one side of the chamber 82. The protrusion 86′ embedded in the chamber 82 isolates the fluid channel 84 and the chamber 82. The width of the fluid channel 84 is less than a half of the chamber 82.

Referring to FIG. 7D, the device structure comprises a substrate 80, a chamber 82, a fluid channel 84, a structural layer 86, a protrusion 86′, a passivation layer 82, and a nozzle 90.

The structural layer 86 covers the substrate 80 and the chamber 82. The protrusion 86′ embedded in the chamber 82 comprises part of the structural layer 86. The passivation layer 88 covers the structural layer 86. A nozzle 90 through the passivation layer 88 and the structural layer 86 is formed and connects the chamber 82.

The invention provides a fluid channel 84 formed inside the chamber 82. According capillary theory, ink is sped toward the terminal of the chamber, thus reducing production of residual bubbles.

The capillary theory can be illustrated by the equation (2), wherein Δp represents driving pressure of ink, σ represents surface tension of ink, r represents equivalent radius of fluid channel, α represents included angle between chamber and ink.
Δp=(2σ/r)cos (α) (2)

According to the above equation, the fluid channel 84 must have smaller equivalent radius (r) than a half of the chamber 82 to form larger surface tension (σ) thereof. Thus, ink can be firstly filled into the terminal region of the chamber 82 through the fluid channel 84 to reduce production of residual bubbles,

Referring to FIG. 7B-7D, a method of fabricating the fluid injection device is provided. First, referring to FIG. 7B, a substrate 80 is provided, such as a silicon substrate. The thickness of the substrate 80 is about 625-675 μm, Subsequently, a patterned sacrificial layer 81 comprising a pair of cavities 82′ is formed on the substrate 80. The sacrificial layer comprises BPSG, PSG, or silicon oxide, preferably PSG. The thickness of the sacrificial layer is about 1-2 μm.

Next, a patterned structural layer 86 is formed on the patterned sacrificial layer 81 and filled into the cavities 81′ to form a pair of protrusions 86′. The structural layer 86 may be silicon oxide nitride formed by CVD. The thickness of the structural layer 86 is about 1.5-2 μm. Finally, a passivation layer 88 is formed on the structural layer 86.

Subsequently, referring to FIG. 7C, the pattern sacrificial layer 81 is removed by HF. The substrate 80 is subsequently etched by a basic etching solution, such as KOH, to enlarge the vacant volume thereof to form a chamber 82 having protrusions 86′, wherein fluid channels 84 are formed between the protrusions 86′ and the chamber 82. The invention is not limited to a pair of fluid channels in both sides of the chamber 82, further allowing formation of a single fluid channel in one side thereof. The protrusion 86′ is rectangular or zigzag with width about 1-3 μm. The fluid channel 84 is narrower than the chamber with equivalent radius about 2-35 μm. Finally, referring to FIG. 7D, the passivation layer 88 and the structural layer 86 are etched in order by plasma etching, chemical vapor etching, laser etching, or reactive ion etching (RIE) to form at least one nozzle 90 connecting the chamber 82.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fluid injection device, comprising:
a substrate;
a chamber formed in the substrate;
a structural layer covering the substrate and the chamber;
at least one nozzle through the structural layer, connecting the chamber; and
a an opening through the structural layer, connecting the terminal of the chamber, wherein an outlet is formed at the connection region there between.

2. The fluid injection device as claimed in claim 1, wherein the terminal of the chamber and the opening are tapered or rectangular, and the outlet is triangular.

3. The fluid injection device as claimed in claim 1, wherein the opening has a smaller equivalent radius than the nozzle.

4. The fluid injection device as claimed in claim 1, wherein the outlet has an equivalent radius of about 2-30 μm.

5. A fluid injection device, comprising:
a substrate;
a chamber formed in the substrate, comprising a fluid channel formed in one side thereof; and
a structural layer covering the substrate and the chamber, comprising a protrusion embedded in the chamber to isolate the fluid channel and the chamber.

6. The fluid injection device as claimed in claim 5, further comprising fluid channels formed on both sides of the chamber.

7. The fluid injection device as claimed in claim 5, wherein the protrusion is rectangular or zigzag.

8. The fluid injection device as claimed in claim 5, wherein the protrusion has a width of about 1-3 μm.

9. The fluid injection device as claimed in claim 5, wherein the fluid channel is narrower than a half of the chamber.

10. The fluid injection device as claimed in claim 5, wherein the fluid channel has an equivalent radius of about 2-35 μm.

11. A method of fabricating a fluid injection device, comprising:
providing a substrate;
forming a patterned sacrificial layer on the substrate, wherein the patterned sacrificial layer is a predetermined region of a chamber;
forming a patterned structural layer on the substrate to cover the patterned sacrificial layer;
forming a manifold through the substrate to expose the patterned sacrificial layer; removing the sacrificial layer to form the chamber; and
etching the structural layer to form at least one nozzle connecting the chamber and an opening, wherein the opening passes through the structural layer and connects the terminal of the chamber, and an outlet at the connection region therebetween is formed.

12. The method as claimed in claim 11, wherein the terminal of the chamber and the opening are tapered or rectangular, and the outlet is triangular.

13. The method as claimed in claim 11, wherein the structural layer comprises silicon oxide, silicon nitride, or a combination thereof.

14. The method as claimed in claim 11, wherein the outlet has a smaller equivalent radius than the nozzle.

15. The method as claimed in claim 11, wherein the outlet has an equivalent radius of about 2-30 μm.

16. A method of fabricating a fluid injection device, comprising:
providing a substrate;
forming a patterned sacrificial layer on the substrate, wherein the patterned sacrificial layer is a predetermined region of a chamber, and at least one side thereof comprises a cavity;
forming a patterned structural layer on the patterned sacrificial layer to fill into the cavity to form a protrusion;
forming a manifold through the substrate to expose the patterned sacrificial layer;
removing the sacrificial layer to form a chamber having the protrusion, wherein a fluid channel is formed within the protrusion and the wall of the chamber; and
etching the structural layer to form at least one nozzle connecting the chamber.

17. The method as claimed in claim 16, wherein the patterned sacrificial layer comprises a pair of cavities, and the structural layer is filled into the cavities to form a pair of fluid channels on both sides of the chamber.

18. The method as claimed in claim 16, wherein the protrusion is rectangular or zigzag.

19. The method as claimed in claim 16, wherein the protrusion has a width of about 1-3 μm.

20. The method as claimed in claim 16, wherein the fluid channel is narrower than a half of the chamber.

21. The method as claimed in claim 16, wherein the fluid channel has an equivalent radius of about 2-35 μm.
